(19) United States
(12) Patent Application Publication
(10) Pub. No.: US 2006/0152688 A1
(43) Pub. Date: Jul. 13, 2006

(54) Illuminating device for projector

(76) Inventors: Wen-Chieh Chen, Jubei City (TW); Shyi-Pyng Lee, Jubei City (TW)

Correspondence Address: LIN & ASSOCIATES INTELLECTUAL PROPERTY, P.O. BOX 2339, SARATOGA, CA, 95070-0339, US

(21) Appl. No.: 11/034,621

(22) Filed: Jan. 13, 2005

(51) Int. Cl. G03B 21/28

(52) U.S. Cl. 353/98

(57) ABSTRACT

An illuminating device for a projector includes a reflector that is arcuate in shape for reflection and a light emitting diode (LED) light source. The LED light source includes a LED chip set and an encapsulation composed of a first dome and a second dome is applied to refract light beams from the LED chip set. The LED light source is located at a focal length of the reflector.

### BACKGROUND OF THE INVENTION

1. Field of the Invention

The present invention relates to an illuminating device, and more particularly to the illumination device for a projector to enhance light convergence from the light emitting diodes of the illumination device.

2. Description of Related Art

With reference to FIG. 1, a conventional illumination device for a projector is shown and has a light source 10, a lens array 13 arranged in front of the light source 10, multiple color defectors 14 and a lens set 15. The light coming from the light source 10 passes through the lens array 13, the color deflectors 14 and is emitted out of the lens set 15. Because the light has to pass through a series of lenses and in order to have enough luminosity for presenting an image, the light source 10 has to have high light intensity. A mercury light bulb 12 is the most frequently used light bulb to accomplish the objective. The position of the light bulb 12 is located at the focal length of a reflector 11 so that a light from a center of the light bulb 12 and reflected by the reflector 11 is parallel to x-axis. However, a light beam 14 coming an area other than the center of the light bulb 12 and reflected by the reflector 11 is not parallel to the x-axis. Therefore, the light distribution from the light bulb 12 and reflected by the reflector 11 is not uniform. Besides, because the bulb protecting the filament of the light bulb 12 is not uniform, the light intensity cannot be distributed uniformly. Furthermore, because the light from the light bulb 12 is distributed divergently from the center of the light bulb 12, when an angle of the light is larger than an angle and the light does not pass through the lens array 15, the light beam is not able to be reflected by the reflector 11 such that the projector suffers from a light intensity loss.

Furthermore, when the mercury light bulb emits light, invisible lights, such as infrared light and violet light, are also generated. The violet light is the cause of the interior deterioration of the projector and may cause injury to the eyes. The infrared light is able to generate massive heat to cause the interior of the projector to be in a high temperature environment, which is also a parameter of interior deterioration of the projector. The light beam overshooting the reflector 11 will cause the peripheries of the projector to suffer from deterioration as well. Still, in order to have high light intensity, the pressure inside the light bulb is high and thus the user's safety becomes a major concern due to the possible explosion of the light bulb. Besides, high temperature will cause the filament to become ionized, which eventually will damage the light bulb and replacement of such an expensive light bulb is necessary. As a result, using this conventional light bulb not only deteriorates the interior elements of the projector, but also increases the cost.

In order to overcome the shortcoming, a conventional method is to use the low cost light emitting diode (LED) as the light source. However, with reference to FIG. 2, the conventional LED chip 20 is encapsulated in a domed shape encapsulation 22. A light beam coming out from the LED chip 20 is emitted through the medium of he encapsulation 22. Due to density difference, refraction is caused and this is the primary reason for limited projection area and the luminosity is not uniformly distributed. Because of high refraction rate, using the LED chip 20 as the light source may only allow a portion of the light beam to be emitted out of the encapsulation 22. That is only the light beam having a incidence angle smaller than a critical angle for reflection is able to be emitted. Those that are not emitted are either absorbed or scattered to places where no image can be presented. A formula (Snell's Law) can be used to calculate the critical angle. The formula indicates C=sin⁻¹(n1/n2) which is the same as Sin(C)=n1/n2, wherein n1=refraction rate of the peripheral material, n2=refraction rate of the LED. For example, when the peripheral material is air, n1=1 and n2=3.4 for the LED, then the critical angle=17.1. The LED chip is normally encapsulated in a material of epoxy having a refraction rate=1.52. The critical angle is 26.2, which is 53% increase of the critical angle. Therefore, it is concluded that after the LED chip is encapsulated by epoxy, the luminosity has a 2.7 times increase over the LED chip not encapsulated. From the conclusion, it is noted that the conventional LED light source suffers a great deal of luminosity loss.

### SUMMARY OF THE INVENTION

The primary objective of the present invention is to provide a light emitting diode for replacement of the conventional mercury light bulb so that with the specially designed encapsulation, the emitted light beams will be focused by the reflector and then uniformly distributed.

Other objects, advantages, and novel features of the invention will become more apparent from the following detailed description when taken in conjunction with the accompanying drawings.

### BRIEF DESCRIPTION OF THE DRAWINGS

FIG. 1 is a schematic view showing the structure and light path of a conventional projector;

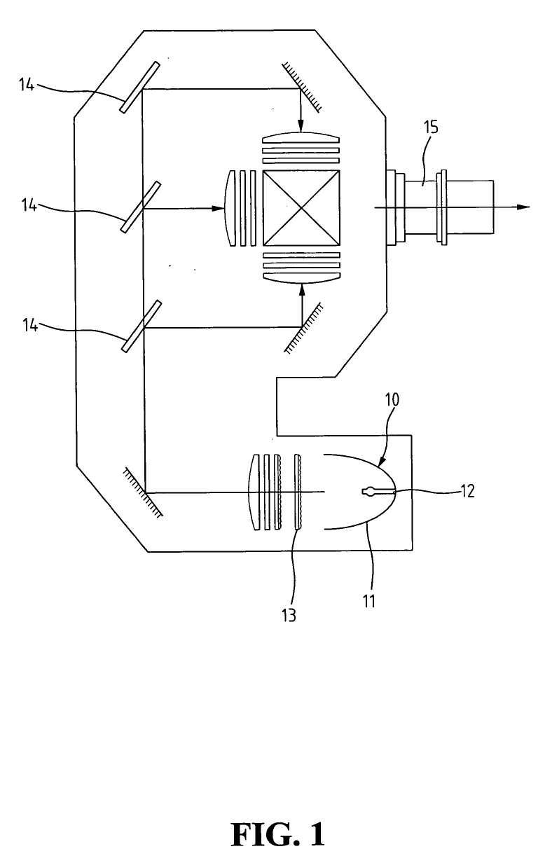

FIG. 2 is a schematic view showing the conventional light source using the light emitted diode and the encapsulation surround the light emitted diode;

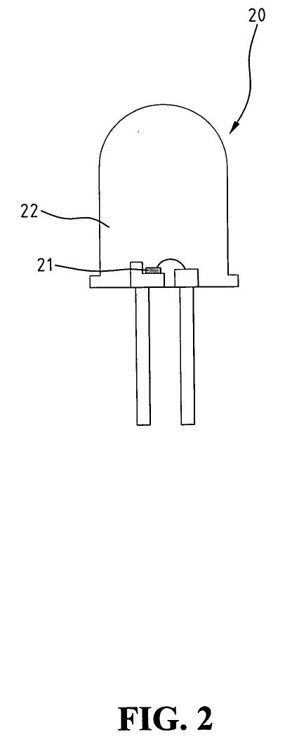

FIG. 3 is a schematic view showing the structure of the light source of the present invention; and

FIG. 4 is a schematic view of the light path from the light source with the encapsulation surrounding the light source of the present invention.

### DETAILED DESCRIPTION OF PREFERRED EMBODIMENT

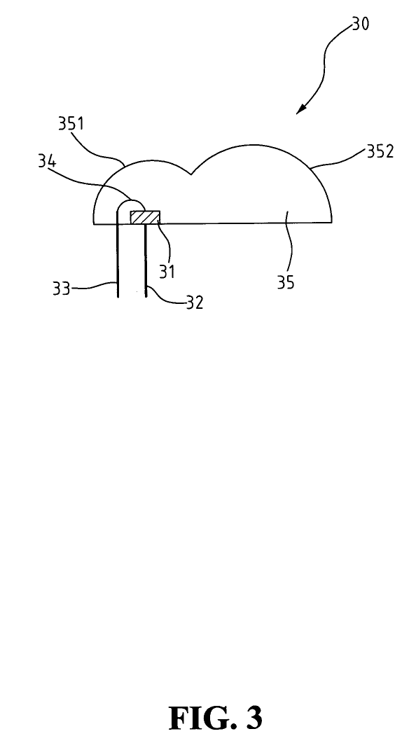

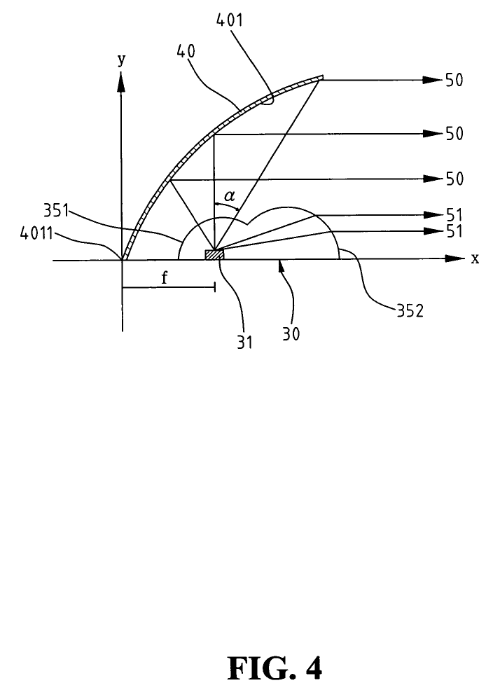

With reference to FIGS. 3 and 4, the illuminating device of the present invention includes a light emitting diode (LED) light source 30 and a reflector 40. The LED light source 30 is composed of a LED chip set 31, a first wiring 32, a second wiring 33, a cable 34, and an encapsulation 35. The encapsulation 35 is provided with two half spherical domes, the first dome 351 and the second dome 352. A light beam from the LED chip set 31 can be refracted by the curve outer periphery of the encapsulation 35 and reflected by the reflector 40 to travel in a single direction so that the LED light source 30 can be used as the light source of a projector. The LED chip set 31 is connected to the first wiring 32 and then the cable 34 is used to connect the LED chip 31 and the second wiring 33. Thereafter, an encapsulation 35 having the capabilities of airproof, waterproof, transparency and heat durability is applied to form a protection outside the LED chip set 31. The encapsulation 35 is composed of two domes, the first dome 351 and the second dome 352. Preferably, the encapsulation 35 is epoxy. The LED chip set 31 is located at a center of the first dome 351 such that a light beam 50 coming out from the LED chip set 31 will come out of the first dome 351. Besides, the second dome 352 is located at the x-axis of the LED chip set 31.

Furthermore, a distance from the LED chip set 31 to a center 4011 of curvature of the reflector 40 is a focal length f of the reflector 40. Therefore, the light beam 50 from the LED chip set 31 is able to be reflected by an inner face 401 of the reflector 40 and traveled in a direction parallel to the x-axis of the reflector 40. After being refracted by the second dome 352, other light beams 51 from the LED chip set 31 will be parallel to the x-axis as well. In order to have all the light beams from the LED chip set 31 will be reflected by the reflector 40 or refracted by the encapsulation 35, the reflector 40 should cover all the effective projection area, at least cover the projection area determined by an angle alpha (α) such that luminosity loss is reduced and the light intensity for presenting the image is enhanced.

The LED light source is a white light LED which may be a blue light LED energizing YAG yellow fluorescent matter, blue light LED energizing the RBG (red, blue and green) fluorescent matter, a ultraviolet light LED energizing the RBG (red, blue, and green) fluorescent matter or a combination of blue LED and a yellow LED or the combination of the blue light LED, the green light LED and the red light LED which are encapsulated together. Another alternative is a combination of the red light LED, blue light LED and he green light LED as the LED light source of the present invention, which triples the light intensity when compared with the single white light LED.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An illuminating device for a projector, the illuminating device comprising:
a reflector which is arcuate in shape for reflection; and
a light emitting diode (LED) light source, which includes a LED chip set; and
an encapsulation surrounding the LED chip set and composed of a first dome and a second dome interconnected to the first dome in such as way that the LED chip set is located at a center of the first dome and a distance from the LED chip set to the reflector is a focal length of the reflector, wherein a center of the second dome is at a position where an x-axis of the LED chip set passes.

2. The illuminating device as claimed in claim 1, wherein the reflector has a dimension to reflect all the light beams refracted by the encapsulation.

3. The illuminating device as claimed in claim 1, wherein the LED light source is a white light LED.

4. The illuminating device as claimed in claim 1, wherein the LED light source is a blue light LED.

5. The illuminating device as claimed in claim 1, wherein the LED light source is a red light LED.

6. The illuminating device as claimed in claim 1, wherein the LED light source is a green light LED.
